(19) United States
(12) Patent Application Publication
(10) Pub. No.: US 2014/0109186 A1
(43) Pub. Date: Apr. 17, 2014

(54) Website Access Parental Management

(71) Applicant: Artases OIKONOMIDIS, Moscow (RU)

(72) Inventor: Artases OIKONOMIDIS, Moscow (RU)

(21) Appl. No.: 13/651,440

(22) Filed: Oct. 14, 2012

(51) Int. Cl. G06F 21/00

(52) U.S. Cl. 726/4

(57) ABSTRACT

Website access parental management techniques block a user device from accessing websites and permit access to a particular website if the received identification of the user device corresponds to a particular registered protected user identification in the records and the particular website corresponds to an approved website identified in a profile of the user. New websites can be approved by administrators and such approval can result in the approved websites being included in the approved website list of the user profile. Secondary administrators with different authorization rights and different approved website lists can be designated to manage the same or different registered protected users.

### TECHNICAL FIELD

The present invention relates to internet access management and, more particularly but not exclusively, to website access parental management.

### BACKGROUND

The internet is now part of the daily lives of both adults and children in the developed world. Children now use the internet in a variety of school and play environments including their own homes, homes of friends or relatives, schools, libraries, recreational parks, etc. Children go online to access information for the purpose of learning as well as for activities that are not related to educational activities. The absence of filters and any review process can result in children being exposed to controversial information. Mechanisms exist to try to stop computers from automatically accessing websites and downloading information. The many different environments in which a child may access the internet and the easy accessibility to online content pose a challenge to parents wishing to control, in a balanced way, children's exposure to inappropriate internet content.

There is a need to provide improved website access control for parents that can manage the ever increasing use of the internet by children in different environments.

### SUMMARY

According to one aspect, there is provided a method of computer-implemented parental website access management. The method may comprise; blocking a user device from accessing websites; receiving, in the user device, identification of a user; accessing, in memory, records of at least one registered protected user; comparing the received user identification to registered protected user identification in the accessed records; blocking user device website access to any websites in response to determining the received user identification does not correspond to a registered protected user identification in the records; and in response to determining the received user identification corresponds to a particular registered protected user identification in the records, permitting the user device to access at least one website corresponding to at least one approved website identified in records of the particular registered protected user.

By permitting the user device to access websites that only correspond to approved websites identified in records of a particular registered protected user in response to verifying, from the received user identification and user records, that the received user identification corresponds to the particular registered protected user identification in the records, parents can be reassured that access to websites via a user device is limited to the websites pre-approved for that particular registered protected user. In this manner, individual specific websites can be pre-approved by parents according to what is appropriate for each particular child.

According to yet another aspect, there is provided an apparatus for website access parental management. The apparatus may comprise: a processor operably connectable to at least one user device; a data bus coupled to the processor; and a computer usable medium embodying computer program code, the computer usable medium being coupled to the data bus; and the computer program code comprising instructions executable by the processor and configured to: block a user device from accessing websites; receive, from the user device, an instruction to access a particular website; receive, from the user device, identification of a user; access, in memory, records of at least one registered protected user; compare the received user identification to registered protected user identification in the accessed records; block the user device website access to any websites if the received user identification does not correspond to a registered protected user identification in the records; if the received user identification corresponds to the particular registered protected user identification in the records, permit the user device to access the particular website corresponding to an approved website identified in the records of the particular registered protected user.

According to another aspect, there is provided a computer-readable medium for website access parental management, the computer-readable medium embodying computer program code, the computer program code comprising computer executable instructions configured for: blocking a user device from accessing any websites; receiving, in the user device, identification of a user; accessing, in memory, records of at least one registered protected user; comparing the received user identification to registered protected user identification in the accessed records; blocking the user device access to websites if the received user identification does not correspond to a particular registered protected user identification in the records; permitting the user device to access at least one website corresponding to at least one approved website identified in records of a particular registered protected if the received user identification and corresponds to the particular registered protected user identification in the records.

### BRIEF DESCRIPTION OF THE DRAWINGS

In order that the present invention may be more readily understood, reference will now be made to the accompanying drawings, in which:

FIG. 1 is schematic of a data processing environment for implementing methods of website access parental management according to embodiments;

FIG. 2 is a schematic of an exemplary website access parental management package for implementing parental management methods according to embodiments;

FIG. 3 illustrates an exemplary protected user profile interface generated by the parental management package of FIG. 2 according to one embodiment;

FIG. 4 illustrates an exemplary administration user interface generated by the parental management package of FIG. 2 according to one embodiment;

FIG. 5 illustrates a secondary administration user interface generated by the parental management package of FIG. 2 according to one embodiment;

FIG. 6 is a flow chart illustrating an exemplary method of website access parental management implemented in the computer data processing environment of FIG. 1 according to one embodiment;

FIG. 7 is a flow chart illustrating an exemplary method of website access parental management implemented in the computer data processing environment of FIG. 1 according to one embodiment;

FIG. 8 is a flow chart illustrating an exemplary method of website access parental management implemented in the computer data processing environment of FIG. 1 according to one embodiment;

FIG. 9 is a flow chart illustrating an exemplary method of website access parental management implemented in the computer data processing environment of FIG. 1 according to one embodiment; and

FIG. 10 is a flow chart illustrating an exemplary method of website access parental management implemented in the computer data processing environment of FIG. 1 according to one embodiment.

### DETAILED DESCRIPTION

In the following description, for purposes of explanation and not limitation, specific details are set forth, such as particular embodiments, procedures, techniques, etc. in order to provide a thorough understanding of the present invention. However, it will be apparent to one skilled in the art that the present invention may be practiced in other embodiments that depart from these specific details.

Methods and apparatus for website access parental management according to the embodiments described herein can be implemented in any type of computer or data processing environment having a processor and a user interface, operatively connected or connectable to the processor. The processor can be coupled to a computer usable medium embodying computer program code via a data bus. The computer program code comprises instructions executable by the processor and configured to implement a website access management device according to the embodiments described herein.

Technical features described in this application can be used to construct various embodiments of website access parental management techniques. According to one approach, there is provided a method of computer-implemented website access parental management which enables user devices to access only those websites that correspond to pre-approved websites identified in records of a particular registered protected user that has been identified as the user of the user device. The term “user device website access” is utilized herein to mean a user device having website access to the extent that the website is displayed for viewing by the end user. Similarly, the term “access a website”, “accessing a website” etc. means access/accessing a website to the extent that the website is viewable on a user device. The term “blocking website access” means blocking the capability of viewing the website. In addition to blocking a user device from connecting to a website server etc., it will be appreciated that it is possible to connect to a website over the internet but yet block the user device from displaying the website to the extent that a user cannot view the website on the user device, i.e. the user device cannot access the website even though the userdevice may be connected to the website.

According to another approach, a primary or secondary administrator is prompted to approve access to a particular website that has not been pre-approved. Such approval can result in the approved website being included in the approved website list of the user profile of the particular registered protected user. One or more secondary administrators may be designated with authorization rights that enable the secondary administrator to decide whether to authorize a particular registered protected user access to a website that corresponds to a website included in the secondary administrators own pre-approved website list. Secondary administrators with different authorization rights and different approved website lists can be designated to manage the same or different registered protected users.

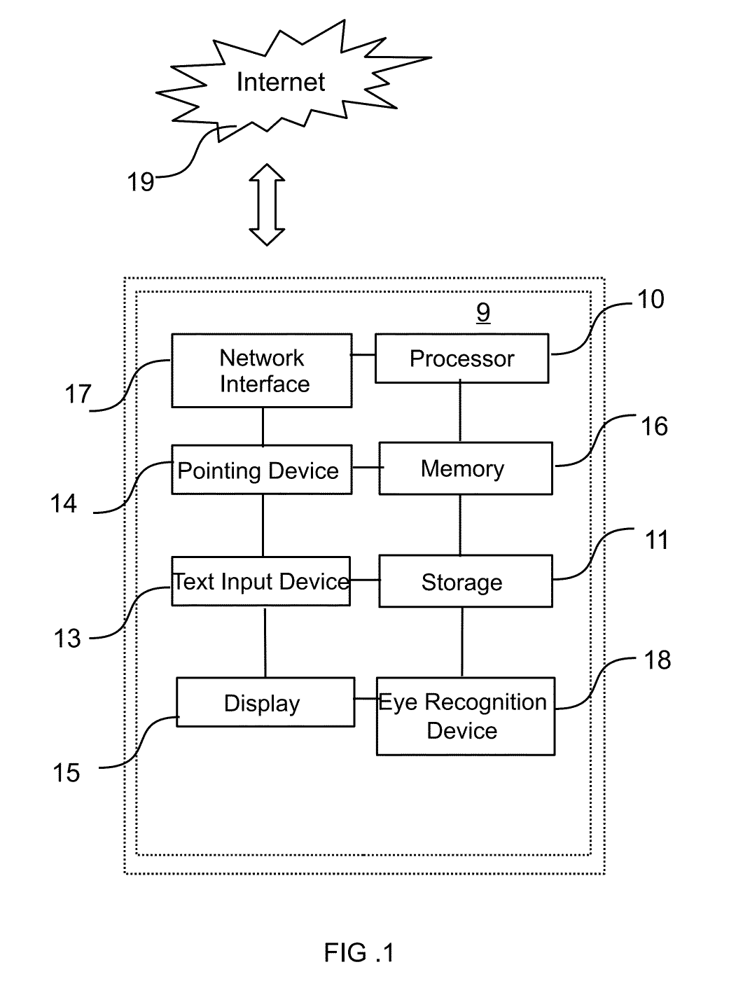

A non-limiting example of the hardware of a data processing system for implementing methods and apparatus of the embodiments will now be described. The data processing system is, by way of example, implemented in a user device 9, such as a desktop or laptop computer having configuration shown in FIG. 1. In other examples, user device 9 may be a server, personal computer, pda phone, notebook, tabletsmartphone or other device or a plurality of devices interconnected over a network. User device 9 has a central processor unit (CPU) or other processor 10, operable to execute a program under control of program software provided in memory 16, such as random access memory (RAM), and also in a storage memory 11 such as a disc drive. The storage memory 11 and the memory 16 are also available to the processor unit 10 for temporary or permanent storage of results and data. A network interface 17 is coupled to the processor unit 10 and permits communication between the processor unit 10 and local and/or external network devices over the internet 19.

The processor unit 10 is coupled to receive input from one or more input devices that may be, but not limited to, a pointing device 14 such as a mouse, pad or touch screen; and a text input device 13 such as a keyboard or touch screen. Other input devices capable of receiving human entered input selections for operating the website access management user interfaces can be adopted in addition or in place of devices 13, 14. The processor unit 10 also drives a display 15 that displays images and provides sounds as controlled and provided by the processor unit 10. Processor unit 10 can be any type or processer that is configurable to run the website access parental management computer program code. Whilst in the example of FIG. 1 the processor unit 10 for processing the website access management application is included in the user device 9, in other non-limiting examples, the processor can be located in a server, personal computer, smartphone, notebook, tablet smartphone or other device.

The processor can be operatively connected or connectable locally to display device 15 or remotely via any suitable remote or local network. Whilst in FIG. 1, display device 15 is included in the user device 9, any type of local or remote display device can be adopted which is configured to render for viewing by a human user the user interfaces generated by the website access parental management application.

Also included in the user device 9 is iris and/or face scan recognition device 18 which is configured to scan the iris and/or face of each user of the device and identify the user from scan and user iris and/or face data pre-stored in the user profile.

The data processing system, as described in relation to FIG. 1, can also be split and disseminated in several parts or network clouds. All that is required, for the embodiments, is that a system can be provided capable of providing the website access parental management functionality of any one or more examples as described hereafter.

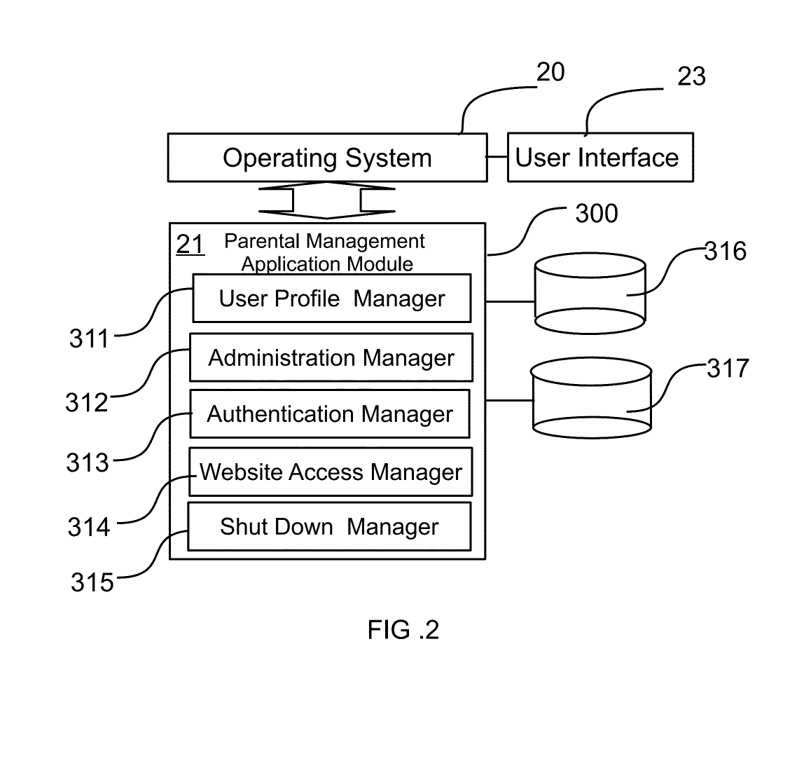

Attention is next drawn to FIG. 2, an exemplary block diagram illustrating the computer software system for directing the operation of the data processing systems of the embodiments. The software system has a parental website access management application module 21, which is stored in system storage/memory. The software system can include a kernel or operating system and a shell or interface. One or more application programs or modules, such as the parental management application software, may be “loaded” (i.e., transferred from storage into memory for execution by the processor. The system receives user commands and data through user interface; these inputs may then be acted upon by the user device 9 or other data-processing apparatus in accordance with instructions from operating module and/or application module.

Note that the term “module” as utilized herein may refer to a collection of routines and data structures that perform a particular task or implements a particular abstract data type. Modules may be composed of two parts: an interface, which lists the constants, data types, variable, and routines that can be accessed by other modules or routines; and an implementation, which is typically private (accessible only to that module) and which includes source code that actually implements the routines in the module. The term “module” may also simply refer to an application such as a computer program design to assist in the performance of a specific task.

The processor unit 10 is organized and driven by operating system 20 that, together with the rest of the computer, runs parental website access management software module 21. Operating system 20 also runs user interface software 23 that, when required, implements the user interface device of display 15 to allow interaction with website access parental management software module 21, internet sites and integral devices such as the pointing device 14, the text input device 13, and with any data input and output sockets.

Application module 21 can include instructions such as the various operations described herein. More specifically, in one example as shown in FIG. 2, application module 21 can include a user profile manager 311, an administration manager 312, authentication manager 313, website access manager 314 and shut down manager 315. As will be explained in more detail below with reference to non-limiting examples, user profile manger module 311 is configured to control, in response to receiving user device inputs, registration of “protected users”, i.e. children to be protected from viewing inappropriate website content, and generate protected user profiles. Administration manager 312 is configured to set and control, in response to receiving user device inputs, various administration operations, such as, assigning particular administrators and administration settings to particular registered protected users, designating administrators as primary or secondary administrators, defining particular administrator settings etc. The authentication manager 313 is configured to control authentication operations, such as, for example, controlling authentication of a particular user of the user device 9. The website access manager 314 is configured to control the user device 9 access to the internet and websites and block or allow access according to receiving instructions from the other modules or user inputs.

Software system can include databases, libraries and other indexable or searchable data storage systems for storing data including, for example, user profile data, administration data and authentication data. Such databases and other storage system can be stored in storage/memory which can be located locally or remotely from the processor. In the example of FIG. 2, the software system also includes storage systems 316 and 317which are user databases, libraries and/or other storage systems that store data associated with the system. Registered user storage system 316 stores data associated with registered protected users of the system. Administrator storage system 317 stores data associated with registered administrators of the system. Whilst the user storage systems 316 and 317 are shown as individual storage, as part of the website access parental management package, they may be implemented as one storage system. Furthermore, one or both storage systems may be implemented separated from the package either locally or remotely.

User interface module 23, which is, for example, a graphical user interface (GUI) module, also serves to display results on the display device, whereupon the user may supply additional inputs or, for example, terminate a given session.

In various other embodiments, the application module 21 can be implemented as a client, as a server, or both a client and server. For server environments, the network on which the server is connected is, for example, the Internet, but equally can be any one of, combination of, or interconnection of, but not restricted to: a local area network (LAN); a wide area network (WAN): a home network; and a wireless network telecommunications.

Turning to the user profile manager 311 in more detail, user profile manager 311 is configured to generate and cause rendering of protected user interfaces to enable registering and management of protected user data. The user data may be entered and stored from another user device or received via the protected user interface. Examples of stored user data are protected user login details for logging into the system as registered protected user, protected user personal details, protected user management settings including but not limited to website address lists of websites that each registered protected user is pre-approved to access and download without any further approval from an administrator, website specific or universal re-authentication and/or website access time data, and user device shut down time data.

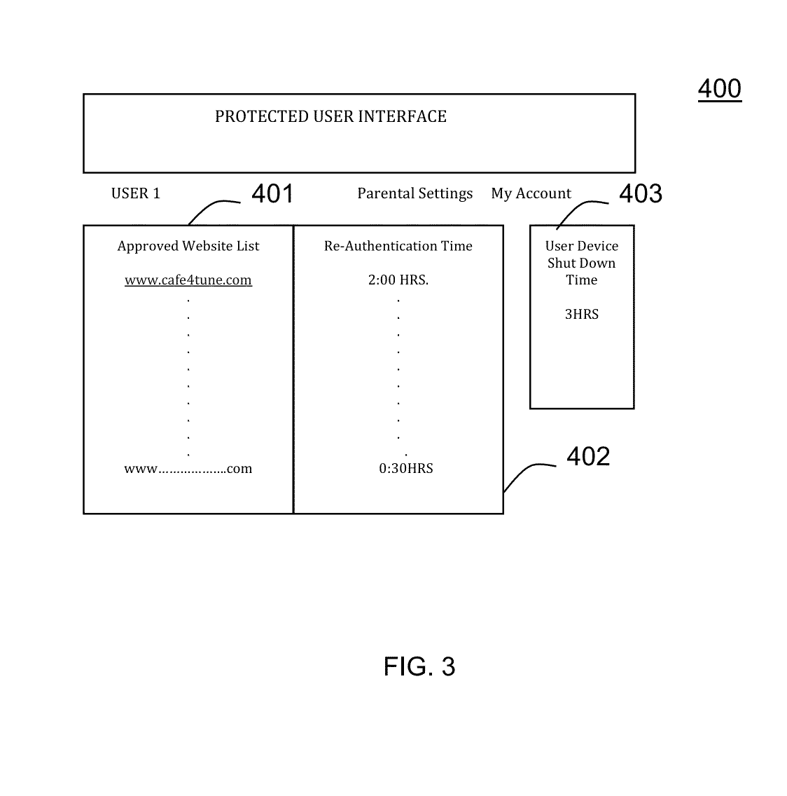

By way of example FIG. 3 is an exemplary screen shot of a registered protected user profile interface 400 showing the website access management settings for a registered protected user according to one embodiment. The exemplary user profile interface 400 includes an example of a pre-approved website list 401, website specific re-authentication times 402, and user device shut down time 403 for a particular registered protected user logged into the website access management package. Note that only particular data that an administrator has approved for manipulation by the protected user is configurable via the protected user interface. Other data including management settings, such as the web access management settings, are configurable via the administrator user interface and are not configurable via the protected user profile interface 400.

Turning now in more detail to administrator manager 312, administrative manager 312 is configured to control, in response to receiving user instructions, user device 9 registration and designation of primary and secondary administrators. Each primary administrator is, for example, a parent of a child and has universal authority for managing website and user device access by one or more particular protected users (e.g. one or more children) Secondary administrators may have different levels of authorization rights and each secondary administrator may have a different authorization management level for a different registered protected user. Examples of authorization rights are: authorization to manage access to particular websites, authorization to set website specific and universal re-authentication times, authorization to set shut down time. Secondary administrators may be, for example, any one or combination of older siblings, grandmothers and child carers.

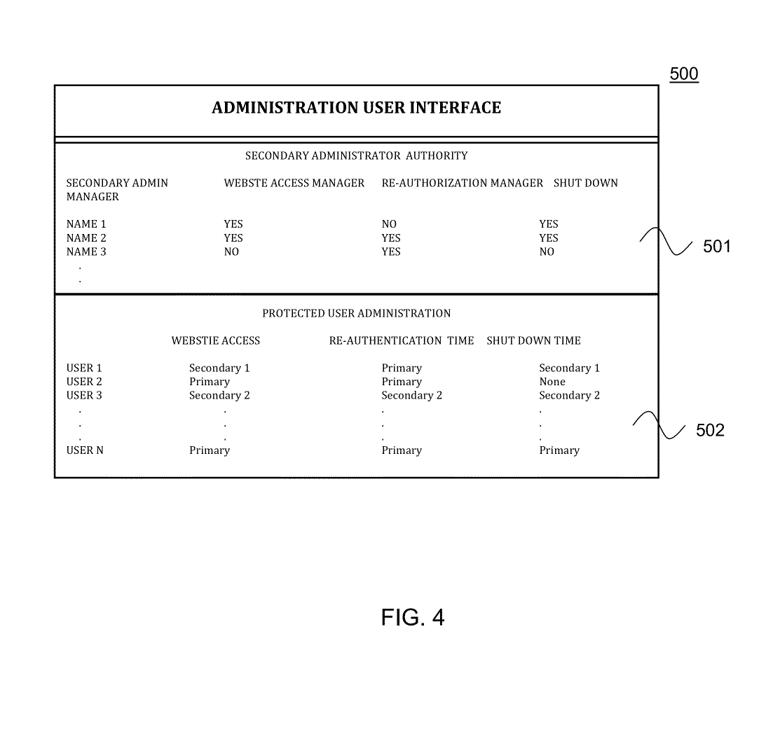

Administrative manager 312 is also configured to manage administrative functionality of the system and administrator records contained in the administration storage system 317 including profile information for the one or more primary and secondary administrators. Examples of such profile information include administration login details for accessing the website access control system and data reflecting the primary and secondary administrators authority to manage particular protected users attempting to access websites. By way of example, FIG. 4 is a screen shot of a primary administrator user interface 500 with management overview selected. Secondary administrator authority window 501 and protected user administration window 502 are shown. Secondary administrator authority window 501 includes names of secondary administrators together with levels of authority for website access, re-authentication and shut down management assigned to each secondary administrator. Protected user administration window 502 shows the level of administrator (primary, secondary, none) controlling website access, re-authentication time, and shut down time assigned to each particular protected user.

A primary administrator, such as a parent, logged into the system can utilize the primary administrator user interface 500 to designate a particular primary or secondary administrator as manager of a particular protected use. Different secondary administrators can be designated to manage different and/or the same respective registered protected users. The level of authority (universal, limited, none) for managing website access, re-authentication time, and shut down time, via the user administrator interface is also configurable via the primary administrator user interface 500 for each particular secondary administrator. “Universal” refers to the secondary administrator having authorization rights to manage website access, re-authentication times, and shut down time parameters. “Limited” refers to the secondary administrator having authorization rights to manage some of these parameters. “None” refers to the secondary administration having no authorization rights to manage these parameters but has access to management view etc. to view administrator settings etc. Note that where a secondary administrator is authorized to perform website access management, (has universal or limited authorization), the secondary administrator cannot authorize a protected user to access a website unless that website is on the website list that the secondary administrator is pre-approved by the primary administrator (parent) to view and authorize access thereto. The list of website address that a particular secondary administrator is authorized to manage access for is configurable via the primary administrator user interface 500. Thus, the authorization rights including pre-approved websites can be customized for a particular secondary administrator and that secondary administrator assigned to manage a particular registered protected user.

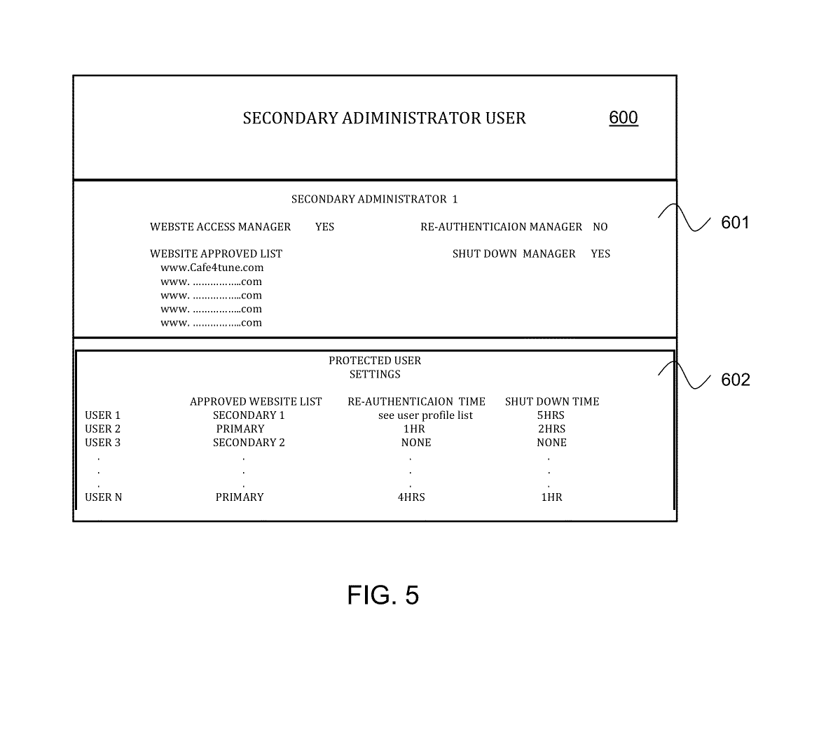

By way of example, FIG. 5 is an exemplary screen shot of a secondary administrator user interface 600 according to one embodiment. Secondary administrator user interface 600 includes a secondary user interface window 601 and protected user settings window 602. Secondary user interface window 601, in this example, shows the logged in secondary administrator 1 has been assigned limited website access management authority by a primary administrator for managing User 1. As already mentioned, limited access management authority means that the secondary administrator has authority to manage some but not all of the following parameters: website access, re-authentication time and shut down time. In the example of FIG. 5, the secondary administrator 1 has authority to manage the following: website access, and shut down time but not re-authorization time (see window 601). As can be seen from window 501, secondary administrator 1 has been assigned to manage user 1 but not user 2 or user 3.

Secondary administrator 2 with customized authorization rights has been assigned to manage user 3. A primary administrator has been assigned to user 2. For the purpose of website access management, secondary user interface window 601 includes the list of website addresses of websites which the secondary administrator 1 is authorized, if the secondary administrator sees fit, to approve access for protected user 1 and, if appropriate, include in the pre-approved website list of the protected user profile. Protected user administration interface window 502 provides an overview of the management level relating to website access, re-authentication time and shut down time for each particular protected user. Secondary administrator interface window 602 allows a secondary administrator to easily determine the protected user settings.

Authentication manager 313 is configured to control the user device to obtain, via the user interface, authentication of the particular user of the user device. Authentication is implemented by the authentication manager each time an input is received in the user device indicating a protected user or administrator is seeking to initiate a new session to access the user device. Authentication is further implemented by the authentication manage module according to the website access control settings of a particular registered protected user logged into the user device, as will be explained in more detail below.

Authentication may be implemented in different ways. In one example, authentication is implemented by iris and/or face recognition device 18 scanning the user and comparing scanned information with pre-stored profile information for a user. In another example, authentication may be implemented via a login user interface of the user device and comparing a user name and password received via the user interface to pre-stored login information for a user.

Methods of website access parental management according to embodiments will now be described with reference to the website access parental management system of FIGS. 1 to 5. It is assumed here that prior to implementing the following methods, the website access parental management package 21 is running on user device 9, primary administrator information for each parent, secondary administrator information for each sibling, grandparent and/or child caregiver, and protected user information for each child to be protected has been inputted into the system and the primary administrator, secondary administrator, and registered protected user accounts set up as described hereinbefore with reference to FIGS. 1 to 5.

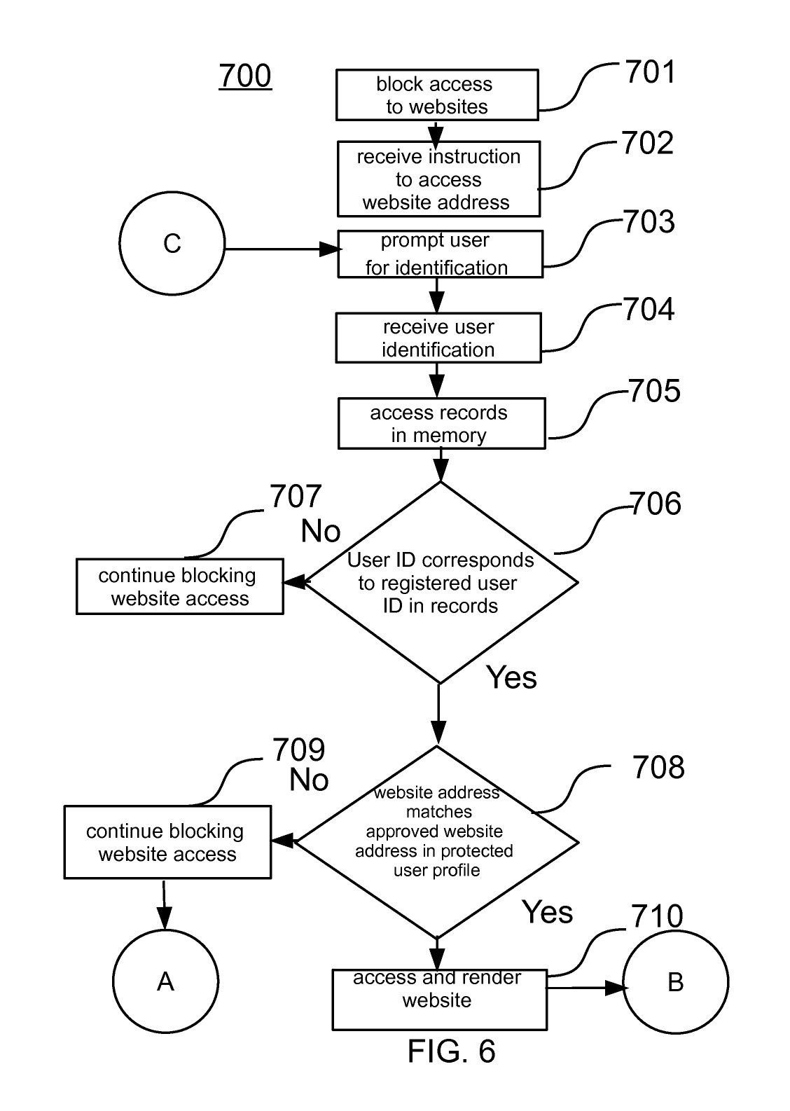

FIG. 6 is a flow chart outlining a method of website access parental management according to one embodiment. Method 700 initiates by the web access manager module blocking the user device from accessing any websites (701) e.g. by blocking the user device from connecting to website addresses or blocking the user device from displaying the website for viewing by a user. An exception to this is where the website access parental management is running on a webserver and must be accessed by the user devices via a website in order for the website access parental management to be implemented on the user device. In such a case, the user device has access to the website access parental management website. A user instruction is received to access a website (702). In this example, a child user enters an instruction into the user device to access a particular website they wish to view. Authentication manager generates a prompt on the user device requesting a user identification (703). The user device receives identification input by the iris/facial recognition system automatically scanning the eye and/or face of the child user. Alternatively, authentication manger causes the user device to display a user login page or window on the user interface in response to receiving an input through the user interface and login inputs are received in response to the child entering login details. In response to receiving a user identification (704), the authentication manager accesses the records in memory (705) and looks for a registered protected user identification (ID) in the records corresponding to the received identification (706). If a match between the received ID and a registered protected user ID in the records is not found, the website access manager continues to block the user device from accessing the internet (707).

If a match between the received ID and a registered protected user ID is found (706), i.e. the received ID is the ID of child registered as a protected user, the protected user (child) is logged in to the application module 21 and the process continues as follows. The website access manager looks to the user data records to determine if the website the protected user child is seeking to access matches an approved website listed in their user profile (708) for example by comparing website IP addresses. If a match between the website and an approved website listed in the user profile is found, the website access manager causes the user device to access the website so that the website is provided on the display of the user device for viewing and manipulation by the protected user (710). If no match is found, the website access manager continues to block the user device from accessing the website (709).

Method 700 ensures that the user device accesses only those websites that correspond to pre-approved websites identified in records of a particular registered protected user that has been identified as the user of the user device. A parent registered as the primary administrator can login to the application software via the user interface and approve a list of websites associated with a particular child registered as a protected user and, with the application software running on the user device, ensure that the software application only allows the child to access the websites in the approved list of their user profile.

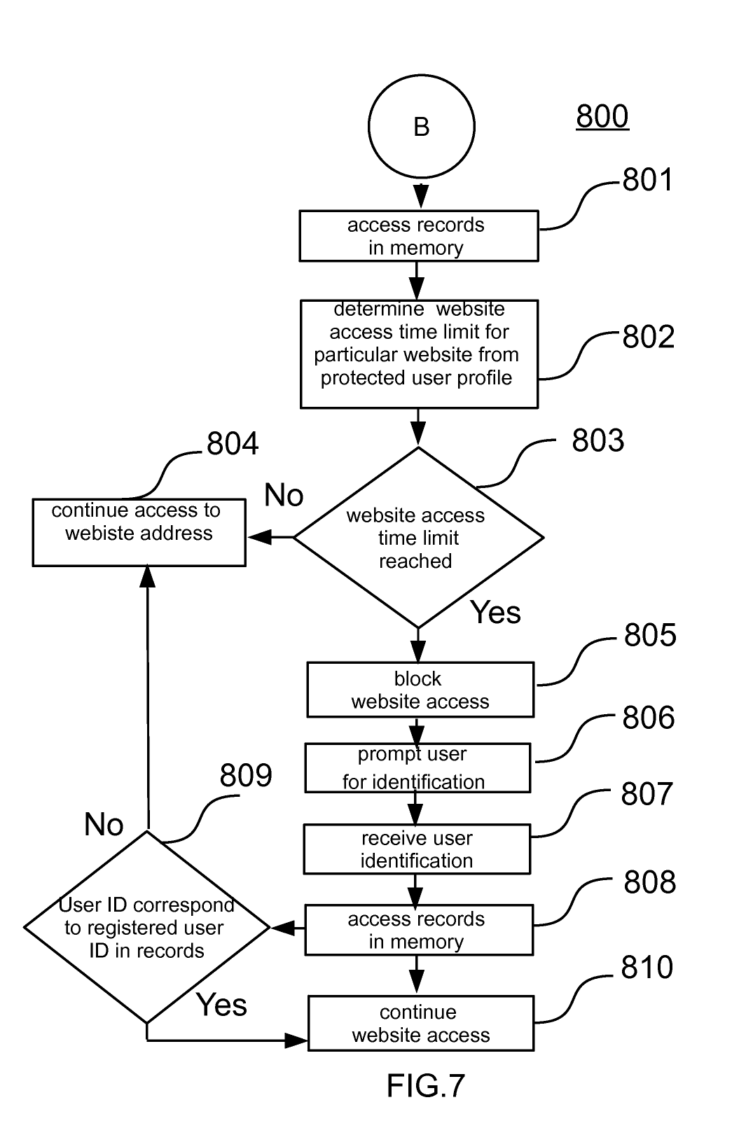

A method of controlling the amount of user device access to the internet according to one embodiment will now be described. Let us assume by way of example that process 700 has been performed and the website access manager is allowing the user device (and therefore the child user) to access the website received via the user interface (710). Method 800 of FIG. 7 is one example of a method of controlling the amount of user device access to the website. The website access manager accesses the stored record data in memory (801) and, from the user profile of the particular registered protected user logged in to the system (the child user), looks up a specific website access time limit that has been set for that particular website (802) (website specific access time limits may also correspond to re-authentication times, such as for example shown in FIG.3). Note that the individual website access times may be set in the user profile by the administrator on a website by website basis or a universal website access time may be set for all pre-approved sites.

Website access manager then determines from the user device hardware the amount of time the user device is accessing the website and compares that time to the website access time limit for that specific website (803). In response to determining that the amount of time that the user device is accessing the website has not reached the specific website access time limit, the website access manager continues to allow the user device to access the website (804). Thus, in this example, the child user can utilize the user device to continue to access and view content in the website. In response to determining that the amount of time that the user device is accessing the website reaches the website access time limit, the website access manager blocks the user device from further accessing the website (805).

Thus, the user device has run out of the approved time for accessing the website and re-authentication of the child user is necessary to utilize the user device to view the site again. To this end, authentication manager proceeds to cause the user device to generate a prompt on the display to enter user identification (806). In response to receiving a user identification in the user device (807), the authentication manager looks to the stored record data to match the received user identification to the previously logged in protected user (808, 809). If a match is found (i.e. the received ID is from same the child user), the website access manager causes the user device to continue accessing the website. If a match is not found, the website access manager causes the user device to block further access to the website (804).

In other examples, re-authentication may be turned off for a particular protected user, in that case, method 800 finishes at process 805. This would then limit the amount of time a protected user can access a specific website to the website specific access time stored in the user profile. The child user's viewing time would therefore be limited according to their user profile settings set by the administrator. Conveniently, the application module can be utilized to manage the amount of time the child can view website content according to the specific website being viewed. For example, the parent may, for example, set a short website access time in the child's user profile for viewing a video game website, but set a longer website access time for viewing a children's movie website.

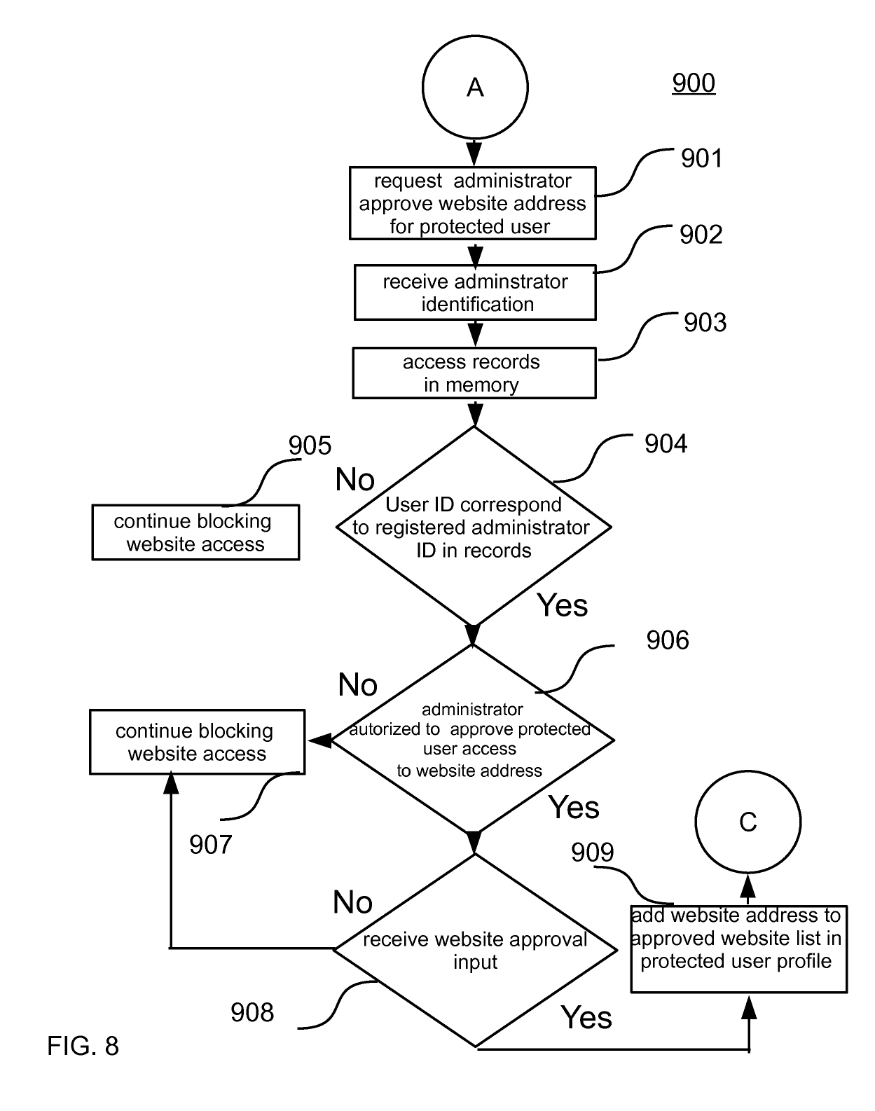

A method of approving user device access to the internet according to one embodiment will now be described with reference to the exemplary method 900 of FIG. 8. Let us assume by way of example that process 700 has been performed and the website access manager is continuing to block the user device from accessing the website because the website the child user is seeking to access is not found in the pre-approved website list in the child user profile (709 of FIG.6). Initially, the website access manager triggers the authentication manager to cause the user device to generate a request prompt on the user device interface (901). The generated request prompt requests an administrator, in this example the parent of the child user, to approve the child user access to the website that the user device is currently blocked from accessing with the child user logged in. For example, the authentication manger causes the user device to display a user administrator login page or window on the user interface.

An identification is received via the user device interface (902). The authentication manager accesses records in memory (903). If the user ID does not correspond to a registered administrator (904), the website access manager continues to cause the user device to block access to the website (905). If the user ID does correspond to an ID of a registered administrator, the authentication manager determines whether the administrator is authorized to approve the protected user access to the website. To this end, the authentication manager looks at the records in memory to determine whether the administrator is so authorized (905).

There are different ways the authentication manager can determine whether the abstract is so authorized. For example, the particular registered protected user profile may have administrator IDs associated therewith that correspond to the administrator(s) that are permitted to approve the particular registered protected user access to one or more particular websites. The authentication manager can look to the protected user profile and determine if the administrator ID is listed in the protected user profile. In another example, each administrators profile can list the particular registered protected user IDs that the administrator is permitted to approve for accessing websites.

In the event that the authentication manager determines that the administrator ID is not associated with an administrator that is authorized to approve the particular protected user's access to the website (904), the website access manager causes the user device to continue blocking website access (905).

In the event that the authentication manager determines that the administrator ID is associated with an administrator that is authorized to approve the particular protected user's access to the website (906), the address or other identifier of the website is added to the approved website list in the protected user profile (909) provided that a website access approval input is received in the user device (908) as a result of the administrator deeming that the website is appropriate for viewing by the protected user. The process then continues. For example, as shown in FIG. 8, the process can then jump to the method 700 and the process of generating a prompt for a protected user identification (702) can follow. The package will cause the user device to access the particular website once the protected user has logged in as a result of the website now being in the protected user's profile. Alternatively, the package can be set to automatically relogin the protected user and continue through to the process 710 of causing the user device to access and download the website.

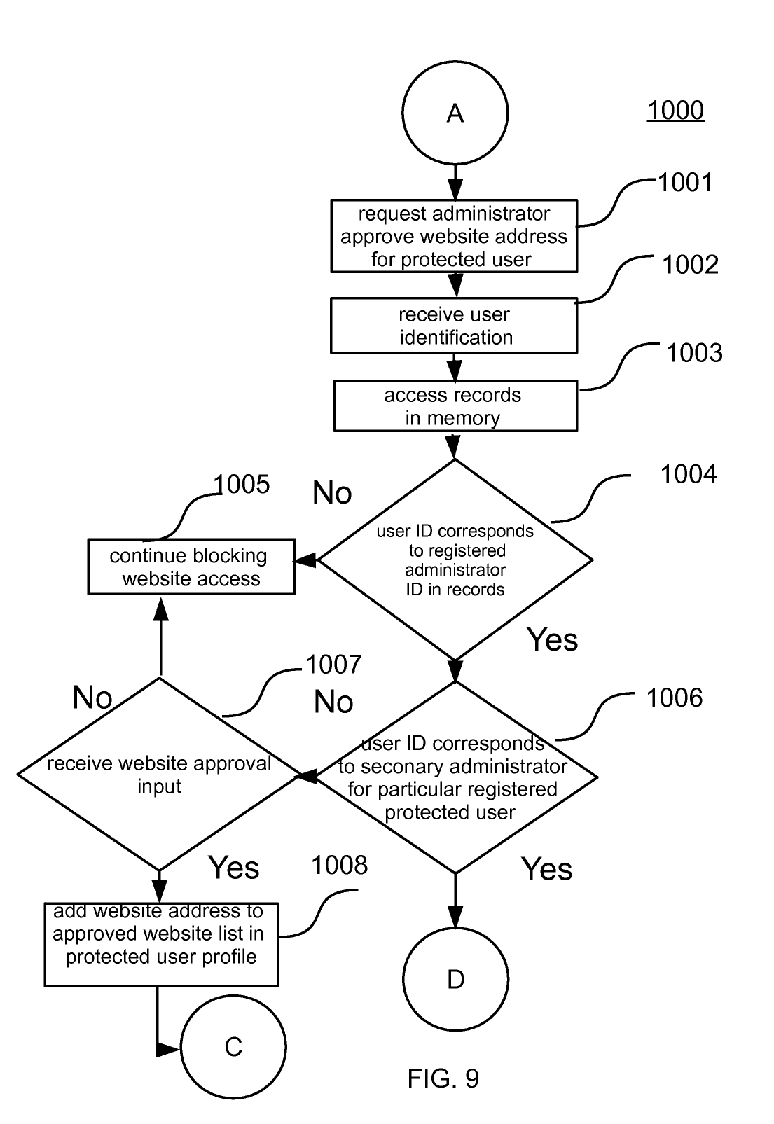

A method of approving user device access to the internet according to yet another embodiment will now be described with reference to the exemplary method 1000 of FIG. 9. Again, let us assume by way of example that process 700 has been performed and the website access manager is continuing to block the user device from accessing the website because the website the child user is seeking to access is not found in the pre-approved website list in the child user profile (709 of FIG.6). Initially, the website access manager triggers the authentication manager to cause the user device to generate a request prompt on the user device interface (1001). The generated prompt requests an administrator approve the protected user access to the website that the user device is currently blocked from accessing with the protected user logged in. For example, the authentication manger causes the user device to display a user administrator login page or window on the user interface. An identification is received via the user device interface (1002). The authentication manager accesses records in memory (1003). If the user ID does not correspond to a registered administrator ID (1004), the website access manager continues to cause the user device to block access to the website (1005).

If the user ID does correspond to an ID of a registered administrator, the authentication manager determines whether the particular administrator ID is a primary or secondary administrator ID (1006). If the administrator ID is a primary administrator ID, i.e. the administrator utilizing the user device is a primary administrator such as a parent etc., the process renders a website approval user interface on the user device and waits to receive a website approval input (1007). If the approval input is received, the address of the website the protected user is seeking to access is added to the protected user profile (1008) and the process continues to point C of FIG. 7. If no approval is received, user device continues to block website access (1005). In one example, the website approval user interface is configured to enable the primary administrator to approve the website access and to select whether to add the particular website to the protected user profile. In such a case, process (1008) may be omitted where there is a selection not to add the website to the list.

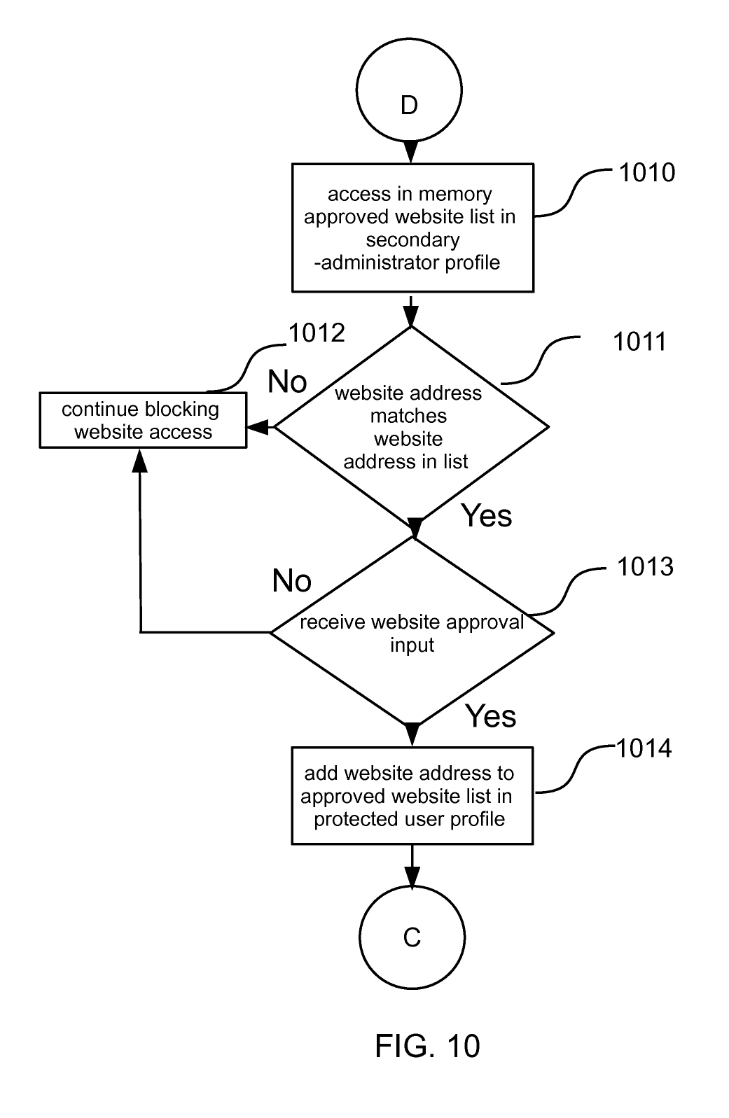

If the administrator ID is a secondary administrator (i.e. the administrator utilizing the user device is a secondary administrator designated to manage the particular registered protected user, such as an older sibling, grandparent or child caregiver rather than a primary administrator (i.e. parent)), the authentication manager then looks to the approved website list in the secondary administrator profile (1010 and 1011 see FIG. 10) to determine whether the particular website that the protected user wishes to access has an address that matches an address on the approved website list in the secondary administrator profile. If there is no match, the website access manager causes the user device to continue blocking access to the website (1012). If there is such a match, the authentication manager generates on the user interface a prompt to approve website access.

If no approval of the website is received, the user device continues to block access (1012). In response to receiving via the user interface a website access approval input from the logged in secondary administrator (1013), the authentication manager adds the address or other identifier of the particular website to the approved list in the user profile of the protected user (1014) and the process continues. For example, as shown in FIG. 9, the process may jump to the method 700 and the process of generating a prompt for a protected user identification (702) may follow. The package will cause the user device to access the particular website once the protected user has logged in as a result of the website now being in the protected user's profile. Alternatively, the package may be set to automatically relogin the protected user and continue through to the process 710 of causing the user device to access and download the website. In one example, the website approval user interface is configured to enable the secondary administrator to approve the website access as well as to determine whether to add the particular website to the protected user profile. In such a case, process (1008) is omitted where there is a selection not to add the particular website address or other identifier. Also, the secondary administrator authorization rights may be configured such that the secondary administrator may or may not have this ability to make such a selection of whether to add the website to the user profile list.

Method 1000 allows a particular secondary administrator to authorize one or more particular registered protected users access to a website that corresponds to a website in the secondary administrators own approved website list. Secondary administrators with different authorization rights and different approved website lists may be designated to manage the same or different registered protected users. In this manner, parents can use the software application not only to selectively control website access and access time to individual particular websites for each particular child, but can also selectively control the ability of each secondary administrator to authorize website access and/or access time for each particular child according to each secondary administrators own pre-approved settings. This means that the parent can use the system to delegate limited responsibility to other users, such as siblings, grandparents and baby sitters (registered as secondary administrators), to approve access according to their own approved website lists. Thus, in such situations, an older sibling, child caregiver, etc. has the ability to decide whether websites that they are themselves pre-approved to access by a parent or other adult are suitable for access by a child and to approve them accordingly.

Such secondary administration enables parents to maintain control to some extent of a child's exposure to inappropriate internet content in different environments where the parent is not present by ensuring that, in the worst case scenario, the child will only be approved to access those websites that have been deemed appropriate for the secondary administrator older sibling, grandparent, baby sitter, etc., and not just any website content. This is practical because there are situations in which parents may not want the older sibling, child caregiver, etc. to have primary administrator rights but may want them to give them at least some control over approving the child's access to new websites. Since an older sibling, baby sitter, etc. is likely to have a more extensive list of websites approved by the parent or another adult than for a younger child, the software module effectively enables the protected child user, with the approval of the younger child or other child caregiver, to access some new websites even when the parent is not present to approve them.

The embodiments and examples set forth herein are presented to best explain the present invention and its practical application and to thereby enable those skilled in the art to make and utilize the invention. Those skilled in the art, however, will recognize that the foregoing description and examples have been presented for the purpose of illustration and example only. Other variations and modifications of the present invention will be apparent to those of skill in the art, and it is the intent of the appended claims that such variations and modifications be covered.

What is claimed is:

1. A computer-implemented website access management method for parental control, comprising:
blocking a user device from accessing websites;
receiving, in the user device, identification of a user;
accessing, in memory, records of at least one registered protected user;
comparing the received user identification to at least one registered protected user identification in the accessed records;
blocking the user device website access in response to determining said received user identification does not correspond to a registered protected user identification in said accessed records; and
in response to verifying the received user identification corresponds to a particular registered protected user identification in said accessed records; permitting said user device to access at least one website corresponding to at least one approved website identified in said records of the particular registered protected user.

2. The method of claim 1, further comprising in response to receiving an instruction to access a particular website;
verifying, from said accessed records and an identity of the particular website, said particular website corresponds to an approved website identified in the accessed records of said particular registered protected user; and
accessing, using said user device, the particular website corresponding to the approved website.

3. The method of claim 1, further comprising
in response to receiving an instruction to access a particular website; verifying, from said accessed records and an identity of the particular website, said particular website does not correspond to an approved website identified in the accessed records of said particular registered protected user;
generating a prompt on said user device requesting an administrator to approve, for the particular registered protected user, user device access to the particular website;
receiving, in the user device, another user identification,
verifying, from the received another user identification and administrator records, said another user identification corresponds to identification in said administrator records of a particular registered administrator with authorization to approve, for the particular registered protected user, user device access to the particular website; and
in response to verifying said another user identification corresponds to said identification of said particular registered administrator, permitting the user device access to the particular website in response to receiving in said user device an input approving said particular website.

4. The method of claim 3, in response to receiving said user device approval input, modifying in memory the accessed records of said registered protected user to include the identity of the particular website as an approved website that the registered protected user is permitted to access.

5. The method of claim 1, wherein permitting the user device to access a website corresponding to an approved website further comprises
determining from said accessed records of the particular registered protected user a pre-approved access time period for accessing the approved website; and
permitting the user device to access the approved website for said access time period.

6. The method of claim 5, further comprising following expiration of said approved access time period, blocking said user device from further accessing said particular website.

7. The method of claim 6, further comprising
generating a prompt on said user device requesting entry of a user identification for further website access;
receiving the user identification; and
permitting the user device to continue accessing the particular website if the received user identification corresponds to the particular registered protected user identification in said accessed records.

8. The method of claim 3,
wherein verifying said another user identification corresponds to identification in said records of said particular registered administrator includes:
verifying said registered protected user records and/or administrator records include a protected user specific authorization for said particular secondary administrator to manage said particular registered protected user; and
verifying the particular website corresponds to an approved website identified in records of the particular registered secondary administrator.

9. The method of claim 1, wherein receiving, in the user device, identification of a user further comprises scanning an iris and/or face of the user utilizing an iris and/or face recognition device.

10. An apparatus for website access parental management, said apparatus comprising:
a processor operably connectable to at least one user device;
a data bus coupled to said processor;
a computer readable medium embodying computer program code, said computer readable medium being coupled to said data bus; and said computer program code comprising instructions executable by said processor and configured to:
block a user device from accessing websites;
receive, from the user device, an instruction to access a particular website;
receive, from the user device, identification of a user;
access, in memory, records of at least one registered protected user;
compare the received user identification to the registered protected user identification in said accessed records;
block the user device website access if said received user identification does not correspond to the registered protected user identification in said accessed records;
if the received user identification and corresponds to the particular registered protected user identification in said accessed records, permitting the user device to access a particular website corresponding to an approved website identified in the records of said particular registered protected user.

11. The apparatus of claim 10, wherein said instructions executable by said processor are further configured to:
receive instructions to access a particular website;
verify, from said accessed records and an identity of the particular website, said particular website corresponds to an approved website identified in the records of said particular registered protected user; and
unblock user device access to the particular website in response to verifying said particular website corresponds to the approved website.

12. The apparatus of claim 10, wherein said instructions executable by said processor are further configured to:
verify, from said accessed records and an identity of the particular website, said particular website does not correspond to an approved website identified in the accessed records of said particular registered protected user;
generate a prompt on said user device requesting an administrator to approve, for the particular registered protected user, user device access to the particular website;
receive, from the user device, another user identification,
verify, from the received another user identification and records, said another user identification corresponds to identification in records of a particular registered administrator with authorization to approve, for the particular registered protected user, user device access to the particular website;
in response to said verification, receive from the user device an input approving said particular website; and
permit the user device access to the approved particular website.

13. The apparatus of claim 10, wherein said instructions executable by said processor are further configured to:
verify, from said accessed records and an identity of the particular website, said particular website does not correspond to an approved website identified in the accessed records of said particular registered protected user;
generate a prompt on said user device requesting an administrator to approve, for the particular registered protected user, user device access to the particular website;
receive, from the user device, another user identification, verify, from the received another user identification and records of administrators, said received user identification corresponds to a particular secondary administrator identification in said records;
verify the particular website corresponds to an approved website identified in records of the particular registered secondary administrator;
receive from the user device an input approving said verified particular website; and
permit the user device access to the verified particular website.

14. A computer-readable medium for website access parental management, said computer-readable medium embodying computer program code, said computer program code comprising computer executable instructions configured for:
blocking a user device from accessing websites;
receiving, in the user device, identification of a user;
accessing, in memory, records of at least one registered protected user;
comparing the received user identification to registered protected user identification in said accessed records;
blocking the user device website access if said received user identification does not correspond to a registered protected user identification in said accessed records; and
permitting the user device to access at least one website corresponding to at least one approved website identified in accessed records of a particular registered protected user if the received user identification and corresponds to the particular registered protected user identification in said accessed records.

15. The medium of claim 14, said computer program code further comprising computer executable instructions configured for:
in response to receiving an instruction to access a particular website; verifying, from said accessed records and an identity of the particular website, said particular website corresponds to an approved website identified in the accessed records of said particular registered protected user; and
permitting the user device access to the particular website corresponding to the approved website.

16. The medium of claim 14, said computer program code further comprising computer executable instructions further configured for:
in response to receiving an instruction to access a particular website; verifying, from said accessed records and an identity of the particular website, said particular website does not correspond to an approved website identified in the accessed records of said particular registered protected user;
generating a prompt on said user device requesting an administrator to approve, for the particular registered protected user, user device access to the particular website;
receiving, in the user device, another user identification, verifying, from the received another user identification and administrator records, said another user identification corresponds to identification of a particular registered administrator with authorization to approve, for the particular registered protected user, user device access to the particular website; and
in response to verifying said another user identification corresponds to identification of said particular registered administrator, permitting the user device access to the particular website in response to receiving in said user device an input approving said particular website.

17. The medium of claim 16, said computer program code further comprising computer executable instructions further configured for:
wherein verifying said another user identification corresponds to identification in said records of said particular registered administrator includes:
verifying said registered protected user records and/or administrator records include a protected user specific authorization for said particular secondary administrator to manage said particular registered protected user; and
verifying the particular website corresponds to an approved website identified in said records of the particular registered secondary administrator.

18. The medium of claim 16, wherein said computer program code further comprising computer executable instructions further configured for:
in response to receiving said user device approval input, modifying in memory the accessed records of said registered protected user to include the identity of the particular website as an approved website that the registered protected user is permitted to access.
